(19) United States
(12) Patent Application Publication
(10) Pub. No.: US 2026/0056524 A1
(43) Pub. Date: Feb. 26, 2026

(54) SYSTEMS AND METHODS FOR REDUCED ENERGY CONSUMPTION OF SMART SOCKETS BASED ON A PREDICTED OCCUPANCY SCHEDULE

(71) Applicant: Honeywell International Inc., Charlotte, NC (US)

(72) Inventors: Velmurugan R, Chennai (IN); Johnson Samathanadurai, Chennai (IN); Shirajul Huk, Madurai (IN); Shanmathi Panneerselvam, Namakkal (IN)

(21) Appl. No.: 18/811,310

(22) Filed: Aug. 21, 2024

(51) Int. Cl. G05B 19/042

(52) U.S. Cl. CPC G05B 19/042; G05B 2219/2639

(57) ABSTRACT

An example system for controlling energy consumption of a region of a building comprises a building access control system that manages access of a user to the region of the building and detects an occurrence of user access events associated with one or more access control devices for the region in the building; one or more smart sockets located in the region of the building, a controller configured to: query an artificial intelligence model to predict an occupancy schedule of the at least one user in the region of the building based the detected occurrences of the one or more user access events; and send a control signal to automatically switch power off or switch power on for the one or more smart sockets in the region of the building based on the predicted occupancy schedule of the at least one user in the region of the building.

### TECHNICAL FIELD

The present disclosure relates generally to smart sockets (e.g., smart electrical sockets), and more particularly to smart sockets that are controllable based on a predicted occupancy schedule to yield enhanced energy efficiency. For instance, the system and methods herein can yield energy savings to a facility (e.g., reduced energy consumption) by permitting smart sockets in a region of the building to be selectively switched on and/or off responsive to a change in an occupancy state in a predicted occupancy schedule of the region as predicted by artificial intelligence (AI) model based on one or more user access events of the region of the building.

### BACKGROUND

Smart sockets provide power to a variety of different devices with corresponding plugs that are plugged into a smart socket and thus draw a plug load from the smart socket. Examples of plug loads include those attributed to equipment (e.g., office equipment) such as computer monitors, task lighting, coffeemakers, vending machines and/or the sockets, etc., among other types of equipment. Smart sockets can include circuitry (e.g., a socket controller) that allows a user or a supervisor to remotely control the smart socket, for instance, to control whether the smart socket provides power to a device that is connected via a corresponding plug to a plug receptacle (e.g., receptacle) of the smart socket. However, whether a particular smart socket is connected via a plug to equipment may, at least in some instances, be unknown (e.g., from the perspective of building management and/or the supervisor). For instance, equipment may not be connected to a smart socket, yet the smart socket may remain powered on (e.g., due to a power schedule associated with the smart socket). Moreover, equipment in a region of a building may remain powered on (e.g., remain accidentally powered on at the end of a shift or workday, etc.) even though a user is not present to actually use the equipment. Thus, in various instances the smart socket may remain powered on e.g., at all times and thereby consume energy even though it may not be necessary to have the smart socket remain powered on at a particular time. Moreover, some power control approaches may be reliant on manual interactions (e.g., a user interacting with a smart socket and/or another component) and/or be reliant on costly and/or complex user detection hardware (e.g., proximity sensors, etc.). It is desirable to have smart sockets that automatically permit reducing energy consumption of a facility in which the smart sockets are located.

### SUMMARY

The present disclosure relates generally to smart sockets, and more particularly to methods and systems with a supervisor (e.g., supervisory controller) that provides a predicted occupancy schedule functionality and is configured to control smart sockets based on the predicted occupancy schedule. An example may be found in system including a building access control system configured to control access to a region in a building, smart sockets in the region of building, and a supervisor that is communicatively coupled to the building access control system and the smart sockets.

The supervisor can be configured to determine a predicted occupancy schedule of one or more users in the region of the building. For instance, the supervisor can determine a predicted occupancy schedule based on one or more user access events associated with the one or more users (e.g., one or more users that have access to the region in the building). The user access events (e.g., building entry and/or building exit events for the one or more users) can be detected by the building access control system. In some instances, the supervisor can determine the predicted occupancy schedule by querying an artificial intelligence model. The predicted occupancy schedule may correspond to a predicted occupancy state of the region in the building for a current time and/or a future time period. The predicted occupancy schedule can be determined for an individual user or a plurality (e.g., group) of users with access to the region. As detailed herein, the artificial intelligence (AI) model can intelligently analyzes user behavior, historical data, and contextual information to optimize power control decisions for the region of the building. With the integration of AI, the systems and methods herein can automate power control decisions based on user presence and historical data. This automation can reduce the need for manual intervention, saving time and effort for users and administrators. For instance, the systems and methods herein can yield significant energy savings by automatically powering off an individual smart socket or a plurality of smart sockets (e.g., a plug top) when users leave (e.g., when a user leaves the region and/or the building at the end of a workday) and also can suggest efficient activation (e.g., powering on) of the at least one smart socket when the user returns to the region and/or building (e.g., when a user first arrives at the region and/or building for a workday).

For example, the supervisor can be configured to control (e.g., power on or power off) one or more smart sockets in the region of the building based on (e.g., in accordance with) the predicted occupancy schedule. Thus, the systems and methods herein can yield improved power savings. For instance, the systems and methods herein are not reliant on a fixed schedule or lighting control program (e.g., which power on or power off smart sockets at the same time of day, etc.), and thereby can be tailored or personalized to an individual schedule or group of schedules of one or more users with access to the region in the building. Additionally, the systems and methods herein do not require the presence of costly and/or complex user presence detection hardware (e.g., motion sensors and/or proximity sensors) that may be utilized by some other approaches. Moreover, the supervisor can be configured to notify at least one user prior to altering power to the smart sockets in accordance with the predicted occupancy schedules. For example, the supervisor can be configured to send (e.g., wirelessly send) a notification to a mobile user device of the one or more users. In such instances, the one or more users can respond to the notification. For instance, the one or more users may respond with an acknowledgement and the supervisor may alter a power state of smart sockets in the region of the building responsive to receipt of the acknowledgement. Conversely, the one or more users may respond with a rejection and the supervisor may delay or cease to alter the power state of the smart sockets in the region responsive to receipt of the rejection. Hence, the systems and methods herein can offer further customization of power control strategies (e.g., by notifying one or more user of a suggested power state change of one or more smart sockets in the region of the building) that is not available in other approaches. Thus, the system and methods herein account for individual user preferences and patterns to create a personalized power control experience. For example, users can schedule the power supply to their respective work area and benefit from AI-driven suggestions (e.g., to power on or power off on or more smart sockets), making power management more intuitive and convenient for the users.

A first example may be found in a system for controlling energy consumption of a region of a building, the system comprising: a building access control system configured to manage access of at least one user to the region of the building and detect for the at least one user an occurrence of one or more user access events associated with one or more access control devices for the region in the building; one or more smart sockets located in the region of the building, the one or more smart sockets each having: a plug receptacle for receiving a plug from an electrical appliance; and a socket controller that is configured to control whether the smart socket switches on or switches off power to the plug receptacle; and a supervisor operatively coupled to the building access control system and each of the one or more smart sockets, the supervisor configured to: query an artificial intelligence model to predict a predicted occupancy schedule of the at least one user in the region of the building based the detected occurrences of the one or more user access events; and send a control signal to automatically switch power off or switch power on for the one or more smart sockets in the region of the building based on the predicted occupancy schedule of the at least one user in the region of the building.

Another example may be found in a method for reducing energy consumption of a region of a building including a plurality of a smart sockets, the method comprising: receiving, from a building access control system configured to manage access of at least one user to the region of the building and detect for the at least one user an occurrence of one or more user access events associated with one or more access control devices for the region in the building, a signal indicative of the detected occurrences of one or more user access events; querying an artificial intelligence model to predict a predicted occupancy schedule of the at least one user in the region of the building based the detected occurrences of the one or more user access events; and sending a control signal to automatically switch power off or switch power on for one or more of a plurality of smart sockets in the region of the building in accordance with the predicted occupancy schedule of the at least one user in the region of the building.

Another example may be found in a supervisor operatively coupled to a plurality of smart sockets in a region of a building and a building access control system of the building, each of the plurality of smart sockets having a housing including one or more plug receptacles, the supervisor comprising: a memory storing non-transitory machine readable instructions; and a processing device operatively coupled to the memory and configured to execute the non-transitory machine readable instructions stored in the memory to: receive, from building access control system configured to manage access of at least one user to the region of the building and detect for the at least one user an occurrence of one or more user access events associated with one or more access control devices for the region in the building, a signal indicative of the detected occurrences of one or more user access events; query an artificial intelligence model to predict a precited occupancy schedule of the at least one user in the region of the building based the detected occurrences of the one or more user access events; responsive to determination of a change in an occupancy state in the predicted occupancy schedule, send a notification indicative of a recommendation to power on or power off the one or more of the plurality of smart sockets to a mobile user device of the a least one user; receive, from the mobile device, an acknowledgement of the notification; and responsive to receipt of the acknowledgment, send a control signal to automatically switch power off or switch power on to at least one of the plurality of smart sockets in the region of the building.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram of an illustrative system;

FIG. 2 is a schematic block diagram of an illustrative system;

FIG. 3 is a schematic block diagram of an illustrative method employed with an illustrative system;

FIG. 4 is an illustrative method for reducing energy consumption of smart sockets based on a predicted occupancy schedule;

FIG. 5A and FIG. 5B show another illustrative method for reducing energy consumption of smart sockets based on a predicted occupancy schedule;

FIG. 6 is a flow diagram showing an illustrative method for reducing energy consumption of smart sockets based on a predicted occupancy schedule; and

FIG. 7 is a flow diagram showing another illustrative method for reducing energy consumption of smart sockets based on a predicted occupancy schedule.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranged by endpoints includes all numbers subsumed within that range (e.g., 1 to 5 includes, 1, 1.5, 2, 2.75, 3, 3.8, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or”unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

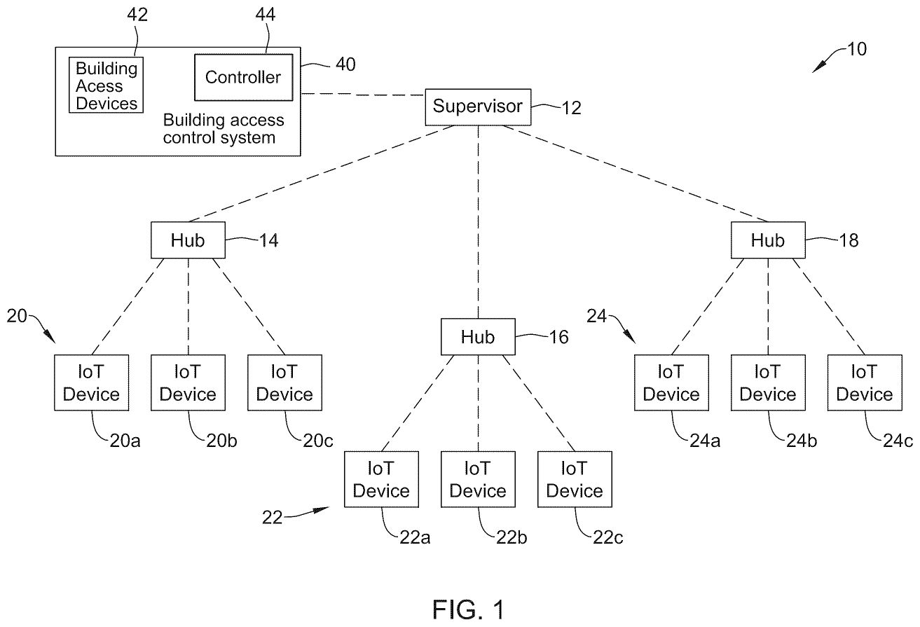

FIG. 1 is a schematic block diagram showing an illustrative system 10. The illustrative system 10 includes a supervisor 12, a first gateway hub 14, a second gateway hub 16, a third gateway hub 18, and a building access control system 40. While a total of three gateway hubs 14, 16 and 18 are shown, it will be appreciated that this is merely illustrative, as the system 10 may include any number of gateway hubs. The system 10 includes a number of IoT (Internet of Things) devices, divided into a first group of IoT devices 20, a second group of IoT devices 22 and a third group of IoT devices 24. The IoT devices within the first group of IoT devices 20 are individually labeled as 20a, 20b and 20c. The IoT devices within the second group of IoT devices 22 are individually labeled as 22a, 22b and 22c. The IoT devices within the third group of IoT devices 24 are individually labeled as 24a, 24b and 24c. This is merely illustrative, as the first group of IoT devices 20, the second group of IoT devices 22 and/or the third group of IoT devices 24 may each include any number of IoT devices, and in some cases may include a substantially larger number of IoT devices.

Each of the IoT devices 20, the IoT devices 22 and the IoT devices 24 may independently be any of a variety of different IoT devices. In general, IoT devices are physical objects having sensors, processing ability, software and/or other technologies that allow the devices to connect with and exchange data with other devices and systems over the Internet and/or other communication networks. IoT devices can include home automation devices, elder care devices, medical devices, transportation devices, vehicle to vehicle communication devices, building automation devices, industrial devices, maritime devices, infrastructure devices, energy management devices, environmental monitoring devices, and others.

In some cases, a smart socket may be considered as being an example of an IoT device. A smart socket includes an electrical plug receptacle (e.g., plug receptacle) that provides power to a device that is plugged into the electrical plug receptacle. In some cases, a smart socket includes circuitry that is able to monitor various aspects of the power being provided to the device, as well as communications circuitry that allows the smart socket to report those power aspects to another device such as a gateway hub and/or supervisor. In some cases, a smart socket can include circuitry that allows a user to remotely control the smart socket to control whether the smart socket provides power to a device that is connected to a plug receptacle of the smart socket. These are just examples.

In some instances, the first group of IoT devices 20 and the first gateway hub 14 may together be considered as forming a first wireless mesh network, the second group of IoT devices 22 and the second gateway hub 16 may together be considered as forming a second wireless mesh network, and the third group of IoT devices 24 and the third gateway hub 18 may together be considered as forming a third wireless mesh network. The devices within the first wireless mesh network communicate in normal circumstances with only the other devices within the first wireless mesh network. The devices within the second wireless mesh network communicate in normal circumstances with only the other devices within the second wireless mesh network. The devices within the third wireless mesh network communicate in normal circumstances with only the other devices within the third wireless mesh network.

The building access control system 40 refers to an access control system including a at least one access control device such as a plurality of access control devices 42 (e.g., smartcard readers) associated with various portions (e.g., doorways) of a building and a controller 44 that is operatively coupled to the plurality of access control devices 42. In the context of the present disclosure, the term “access control device” refers generally to any device having an “access control” functionality. That is, any device with which a user interacts to gain access to a physical region or virtual functionality. An access control device includes hardware and software components. Common examples include devices that control locking mechanisms on doors or other barriers, or that control automatic doors, elevators, etc.

Access control devices 42 and/or the controller 44 can include includes a processor (not illustrated) coupled to a memory (not illustrated). Memory can store software instructions which, when executed on processor, can facilitate various functions of the access control to perform various methods and functionalities described herein. The access control devices herein are configured for selectively granting access to a controlled functionality. In particular, a processor can be coupled to a controlled functionality actuator. For example, in one embodiment the actuator locks and/or unlocks an external device in the form of a door. These are just examples, other configurations and/or functions of the access control device are possible. In some instances, a user wishing to gain access to the controlled functionality actuator presents an access token to device. In the present example, the token takes the form of a smartcard, which is presented to a smartcard reader, which is also coupled to processor. Upon presentation of the smartcard, a processor (e.g., a processor of the controller 44) performs an authorization or authentication process to determine whether or not access should be granted. In the event that the authorization/authentication process is successful, actuator grants access. If the process is unsuccessful, actuator denies access (achieved optionally either by inactivity or positive action). The process whereby a user presents a smartcard (or other token), and the token is read and data processed, is presently referred to as an access control event (e.g., an access transaction).

The building access control system 40 can be configured to a store user access events, for instance, a plurality of user access events for a region of a building. In some instances, an access control device can be present at an entrance of the building, at an entrance of the region, or both. For instance, an access control device can be disposed at an entrance of the building and/or an entrance the region in the building. In such instances, the user access events can correspond to one or more users entering or exiting the access control device at the entrance of the building and/or the entrance of the region of the building. The region of the building can correspond to an individual room, a collection of some but not all rooms in the building, or each of the rooms in the building. For instance, the region of the building can be a room or collection of some but not all rooms in the building in which one or more users are predominantly located within during the course of a workday.

That is, access control systems are employed to control access by users to facilities, equipment and other assets. As mentioned, typically users are issued with respective tokens—for example, an RFID card—that contain data indicative of at least an identifier for the user. Examples of building access control systems are disclosed in No. PCT/AU2005/001285, entitled, “AN ACCESS CONTROL SYSTEM AND A METHOD OF ACCESS CONTROL”, AU2009901185A0, entitled, “SYSTEMS AND METHODS FOR MANAGING ACCESS CONTROL DEVICES”, and U.S. Pat. No. US8707414B2, entitled, “SYSTEMS AND METHODS FOR LOCATION AWARE ACCESS CONTROL MANAGEMENT, the disclosures of each of the above referenced applications are incorporated herein by way of reference.

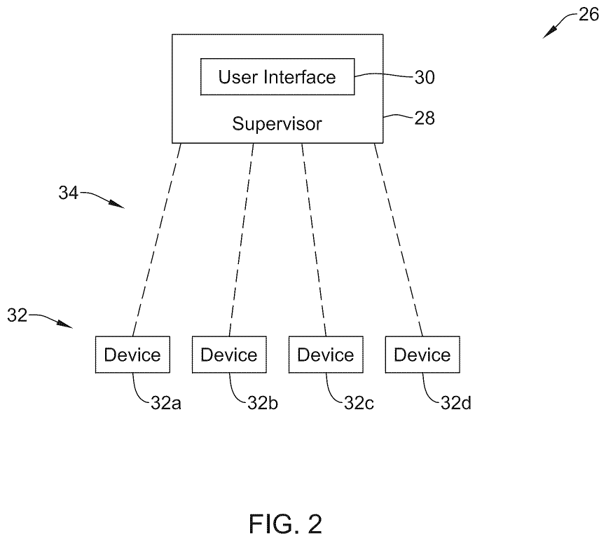

FIG. 2 is a schematic block diagram showing an illustrative system 26. The illustrative system 26 may be considered as being an example of the system 10, and vice versa. The system 26 includes a supervisor 28. The supervisor 28 may be manifested as an application executing on a computer such as a computer server and/or a smartphone and/or may be manifested as an application that is operatively coupled to a memory. The supervisor 28 may include or be configured to facilitate display of a user interface 30. In some cases, the user interface 30 may be a display for displaying information or may be configured to display information via a display. In some cases, the user interface 30 may include or be operatively coupled to a data entry device such as a keyboard, mouse, trackball or electronic writing surface. In some cases, the user interface 30 may include a touch screen that functions as a display as well as providing data entry functionality.

The illustrative system 26 includes a number of devices 32 that are operatively coupled in wireless network such as a wireless mesh network 34. The devices 32 are individually labeled as 32a, 32b, 32c and 32d. While a total of four devices 32 are shown, it will be appreciated that this is merely illustrative, as the system 26 may include any number of devices 32, and in some cases may include a substantially greater number of devices 32. In some cases, some of the devices 32 may represent gateway hubs. In some cases, at least some of the devices 32 may be IoT devices. These are just examples.

In some cases, the IoT devices may include one or more smart sockets, as detailed herein, and the supervisor 28 may be operatively coupled to some or all of the one or more smart sockets. In such instances, the supervisor 28 may be configured to query an artificial intelligence model to predict an occupancy schedule of the at least one user in the region of the building based the detected occurrences of the one or more user access events and send a control signal to automatically switch power off or switch power on for one or more smart sockets in the region of the building based on the predicted occupancy schedule of the at least one user in the region of the building. The controllers and/or supervisor 28 can include one or more processing devices (not illustrated) and one or more memories (not illustrated) for storing non-transitory machine-readable instructions and data used, generated, or collected by the processing device(s). Each processing device (e.g., a hardware processing device) can execute instructions, such as those that may be loaded into or otherwise stored on a memory. The instructions could be used for various aspects herein pertaining to reducing energy consumption of a region of a facility. For instance, the instructions can include instructions to receive, from building access control system configured to manage access of at least one user to the region of the building and detect for the at least one user an occurrence of one or more user access events associated with one or more access control devices for the region in the building, a signal indicative of the detected occurrences of one or more user access events; query an artificial intelligence model to predict an occupancy schedule of the at least one user in the region of the building based the detected occurrences of the one or more user access events; responsive to determination of a change in an occupancy state in the predicted occupancy schedule, send a notification to a mobile user device of the a least one user; receive, from the mobile device, an acknowledgement; and responsive to receipt of the acknowledgment, send a control signal to automatically switch power off or switch power on to at least one of the smart sockets in the region of the building. The processing device includes any suitable processing device, such as one or more microprocessors, microcontrollers, digital signal processors, application specific integrated circuits (ASICs), field programmable gate arrays (FPGAs), or discrete circuitry. The memory and a persistent storage are examples of storage devices, which represent any structure(s) capable of storing and facilitating retrieval of information (such as data, program code, and/or other suitable information on a temporary or permanent basis). The memory may represent a random-access memory or any other suitable volatile or non-volatile storage device(s). The persistent storage may contain one or more components or devices supporting longer-term storage of data, such as a read only memory, hard drive, flash memory, or optical disc. The controllers and/or supervisor could also include at least one network interface, such as one or more Ethernet interfaces or wireless transceivers.

The supervisor 28 can be configured to store a predicted occupancy schedule including one or more predicted occupancy states associated with a region of a building including the one or more smart sockets. The occupancy states can include an occupied state (e.g., user present state) and/or a predicted unoccupied state (e.g., user absent state). The predicted occupied state can correspond to the presence of at least one user in a region of the building. Conversely, the predicted unoccupied state can correspond to an absence of any users within the region of the facility.

The supervisor 28 can be configured to detect a change (e.g., a predicted change) in an occupancy state of the region of the building. For instance, the supervisor 28 can predict a change in the occupancy state of the region of the building based on the predicted occupancy schedule including one or more predicted occupancy states (e.g., of the region in the building). For example, the supervisor 28 can compare an occupancy state (e.g., a current or most recent occupancy state) stored in a memory (e.g., predicted for a current time or future time in the predicted occupancy schedule) to a predicted occupancy state (e.g., for a future time) in the predicted occupancy schedule. In some instances, the supervisor 28 can determine a change in an occupancy state when a current occupancy state (e.g., an unoccupied state) is different than a predicted occupancy state (e.g., an occupied state). For instance, the predicted occupancy state can correspond to an occupancy state at a future time in the predicted occupancy schedule. The supervisor 28 can be configured to continuously, periodically, or responsive to an input detect whether or not a change in an occupancy state is predicted to occur based on the predicted occupancy schedule.

Responsive to detection of the change in the occupancy state, the supervisor 28 can send a control signal to automatically switch power off or switch power on for one or more smart sockets in the region of the building. For example, in response to in response to predicting a change from an unoccupied state to an occupied state in the predicted occupancy schedule, the supervisor 28 can be configured to send a control signal to switch power on to the one or more of the smart sockets. For instance, a control signal can be sent from the supervisor 28 to an individual smart socket to switch power on for one or more plug receptacles in the individual smart socket. Conversely, in response to predicting a change from the occupied state to the unoccupied state in the predicted occupancy schedule, the supervisor 28 can be configured to send a control signal to the one or more of the smart sockets that causes the corresponding socket controller to switch off power to the corresponding plug receptacle in the one or more smart sockets.

In some examples, a control signal can be sent from the supervisor 28 to an individual smart socket to switch power on or off for an individual plug receptacle (e.g., which is associated with or assigned to a particular user or group of users for which the predicted occupancy schedule is determined). That is, the systems and methods herein can permit selectively providing power to smart sockets based on the predicted occupancy schedule of one or more users in a region. For example, the control signal can be sent based on a predicted occupancy schedule of an individual user or a group of users of the region of the building. In the group context, the control signal may correspond to a predicted entry and/or exit time of one or more users of the group of users. For example, a predicted occupancy state change may correspond to a predicted time when a first user of the group arrives at the building and/or the region of the building or may correspond to a time when a last user of the group departs from the building and/or the region of the building, among other possibilities. Similarly, a predicted occupancy state change corresponds to when an individual user arrives or departs from the building and/or the region in the building. In some instances, a user can be a worker in the region of the building or can be a supervisor or other type of user (e.g., a custodian) associated with or working in the region of the building, among other possible types of users.

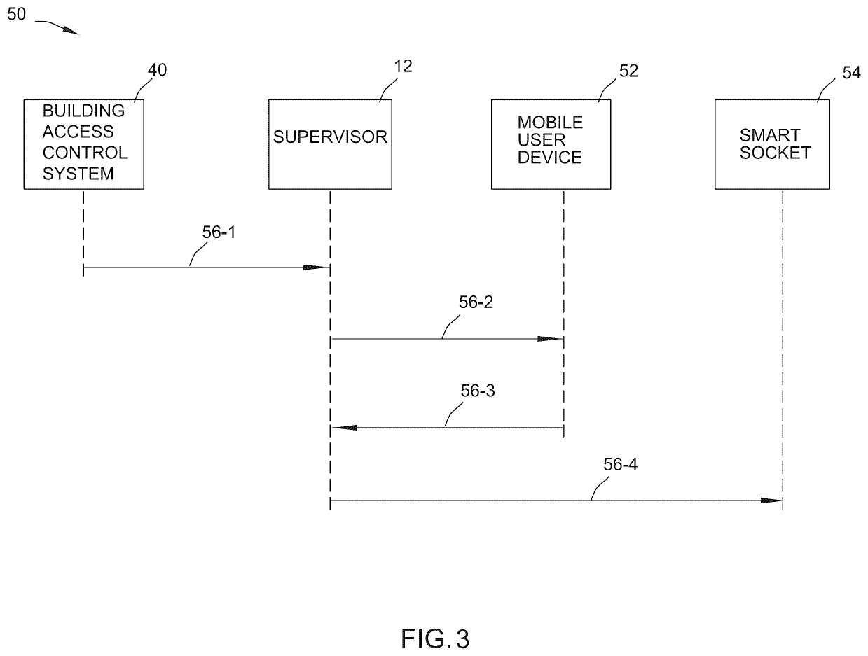

FIG. 3 is a schematic block diagram of an illustrative method employed with an illustrative system 50. As illustrated in FIG. 3, the system 50 includes a building access control system 40 configured to control user access to a region of a building, a supervisor 12, a mobile user device 52, and at least one smart socket 54 in the region of the building. The building access control system 40 can be analogous to the building access control system 40, described with respect to FIG. 1. The supervisor 12 can be analogous to the supervisor 12 and supervisor 28, described with respect to FIG. 1 and FIG. 2, respectively. The supervisor 12 can be communicatively coupled to the building access control system 40, the mobile user device 52, and/or the at least one smart socket 54. For instance, the supervisor 12 can be communicatively coupled in a wireless manner to each one of the building access control system 40, the mobile user device 52, and the at least one smart socket 54.

The mobile user device 52 refers to a mobile phone, a smartwatch, a tablet, or other type of wireless electronic device. For instance, the mobile user device 52 may be a table or mobile phone. The mobile user device 52 can be assigned to or otherwise associated with a user that has access via the building access control system 40 to the region of the building. For instance, the mobile user device 52 can be an individual device or collection of devices that are assigned to an individual user with access to the region of the building. In some instances, the supervisor 12 can be configured to store an association between the mobile user device 52 and the user with access to the region of the building. However, the association may be otherwise stored (e.g., in a local server or in a cloud server) and be accessible (e.g., downloadable) by the supervisor 12.

The smart socket 54 includes a housing. The housing houses a number of components of the smart socket, although some components of the smart socket may be considered as being accessible from a position exterior to the housing. The smart socket includes one or more plug receptacles. The one or more plug receptacles are configured to receive an electrical plug of an electrical appliance. The smart socket 54 includes one or more power connection(s) for connecting to a power source. In some cases, the power connection(s) may include a live connection, a neutral connection and a ground connection. The power connection(s) may include one or more wiring terminals for connecting to power line wires. The power connection(s) may additionally or alternatively include one or more wires. The smart socket 54 includes power input port that is configured to receive input power from the power connection(s). In some cases, the power connection(s) include a live connection and a neutral connection, and a switch (e.g., an isolation switch) is electrically coupled between the live connection and the power input port. The switch, when in a closed position, allows power to pass from the power connection(s) to the power input port, and when in an open position, does not allow power to pass from the power connection(s) to the power input port thereby isolating the power input port from the power source for at least some of the plug receptacles. For instance, power may be turned off or on via the switch for a given plug receptacle independent of whether power is turned off or on for another plug receptacle in the smart socket 54. In various embodiments, the switch can be configured to move between the closed position and the open position responsive to receipt of a signal such as a signal received from the socket controller (e.g., which receives a signal from the supervisor).

The smart socket 54 includes a socket controller and a wireless communication circuit. The socket controller is operatively coupled with at least each of the receptacle switch and a wireless communication circuit. The socket controller is configured to receive from a meter one or more of the captured electrical characteristics of the power that is delivered to the corresponding plug receptacle and to transmit via the wireless communication circuit one or more power parameters that are based at least in part on one or more of the received electrical characteristics of the power that is delivered to the plug receptacle. The socket controller is configured to receive one or more commands via the wireless communication circuit, including a command that causes the socket controller to switch the appropriate receptacle switch between the closed position and the open position to power on or power off one or more of the plug receptacles (e.g., based on a predicted occupancy schedule and/or a change in an occupancy state, as described herein). For instance, the socket controller may be configured to transmit and/or receive one or more commands (e.g., transmitting or receiving command from the supervisor 12) via the wireless communication circuit including a command that causes the socket controller to switch power on or off to one or more plug receptacles in the smart socket 54.

In some instances, the supervisor 12 can be configured to transmit (e.g., wired and/or wirelessly) signals with the building access control system 40. For instance, the supervisor 12 can wirelessly receive, from the building access control system 40 (e.g., which is configured to manage access of at least one user to a region of a building and detect for the at least one user an occurrence of one or more user access events associated with one or more access control devices for the region in the building), a signal indicative of the detected occurrences of one or more user access events, as indicated at 56-1.

The supervisor 12 can be configured to query an artificial intelligence model to predict an occupancy schedule of the at least one user in the region of the building based the detected occurrences of the one or more user access events (e.g., as received at 56-1). The predicted occupancy schedule may correspond to a future time period that is yet to occur, while the one or more user access events may include historical user access events of the one or more users that correspond to a past time period which has already occurred (e.g., have already occurred prior to a time at which the artificial intelligence model is queried by the supervisor 12). As mentioned, the detected occurrences of the one or more user access events can be specific to an individual user with access to the region of the building or can specific each user in a group of users each having access to the region of the building.

The artificial intelligence model may be customized for the purposes herein or may be a general-purpose artificial intelligence model. The artificial intelligence model may be cloud-based, remotely run, or locally instantiated. In some instances, the artificial intelligence model can be stored in part or in its entirety on a memory of the supervisor 12 or may be otherwise stored and accessible by the supervisor 12. For instance, the artificial intelligence model can be stored on a server (e.g., a web server) or other device that is communicatively coupled to and accessible to the supervisor 12. The devices and methods explained in the present disclosure involve the use of processing with artificial intelligence models. The artificial intelligence model may be one or more of a machine learning model (MLM) or a large language model (LLM). For purposes of this disclosure, a “large language model” is a computerized neural network of numerous (e.g., one million or more) parameters, pre-trained on a data set (e.g., of more than one million language tokens). One of ordinary skill will recognize a variety of LLM approaches and machine-learning techniques introduced in the art, including unidirectional and bidirectional frameworks, feed-forward and feedback connections, attention mechanisms, and transformers with a variety of features. Specific examples of suitable types of artificial intelligence models include reinforcing learning (RL) agents, natural language processing (NLP) models, and time series forecasting models. For example, RL agents may be employed to dynamically adjust priorities and provide real-time notifications. NLP models may be employed to enhance the efficiency of user interactions and confirmations. Time series forecasting models may be used to predict future events by analyzing historical data trends, based on the assumption that future trends will mirror those of the past.

In some instances, a predicted occupancy schedule of one or more users in a region of a building can be determined by the artificial intelligence model. For instance, the artificial intelligence model can determine the predicted occupancy schedule based on one or more user access events in the building that are attributed to the one or more users. The supervisor 12 can be configured to query the artificial intelligence model to predict (or update) the predicted occupancy schedule responsive to an occurrence of a first user access event associate with the region of the building during a time period and/or responsive to an occurrence of a last user access event associated with the region of the building during a time period. Thus, the systems and methods herein can power on or power off one or more smart sockets (e.g., one or more smart sockets in a plug top) automatically in accordance with the predicted occupancy schedule (e.g., to align with the user's arrivals and departures from the building).

In some instances, the supervisor 12 can be configured to store the predicted occupancy schedule. For instance, the supervisor 12 can store the predicted occupancy schedule in a memory in the supervisor 12 and/or can store the predicted occupancy schedule elsewhere in a location that is external to but accessible by the supervisor 12.

The supervisor 12 can be configured to send a control signal to automatically switch power off or switch power on for the one or more smart sockets in the region of the building based on the predicted occupancy schedule of the at least one user in the region of the building. The supervisor 12 can be configured to predict a change in the occupancy state of the region in the building based on the predicted occupancy schedule, as detailed herein. For example, the supervisor 12 can be configured to send the control signal to automatically switch power off or switch power on for one or more smart sockets in the region of the building in accordance with one or more predicted occupancy states in the predicted occupancy schedule.

For instance, the supervisor 12 can be configured to send the control signal to automatically switch power off or switch power on for the one or more smart sockets, responsive to detection of the change in the occupancy state of the region of the building based on the predicted occupancy schedule. For example, the supervisor 12 can be configured to: in response to predicting a change from an unoccupied state to an occupied state in the predicted occupancy schedule, the supervisor 12 is configured to send a control signal to switch power on to the one or more smart sockets; and in response to predicting a change from the occupied state to the unoccupied state in the predicted occupancy schedule, the supervisor 12 is configured to send a control signal to switch power off to the one or more smart sockets.

In some instances, the supervisor 12 can be configured to send a notification to a mobile device that is assigned to or otherwise associated with a user with access (e.g., as determined by the building access control system 40) to a region of the building, as indicated at 56-2. For instance, the notification can be manifested as a recommendation or suggestion for the user to acknowledge a change in a power state (e.g., power on or power off) of one or more smart sockets in the region of the building. The notification can be provided via a text message, email message, an application prompt (e.g., text and/or a graphical prompt provided via an application executing on the mobile user device 52), or otherwise provided via the mobile user device 52. The notification may include identifying information of the building, the region or the building, and/or equipment (e.g., individual identifying information associated with one or more smart sockets in the region of the building), among other possible types of identifying information. Thus, the notification may be configured to indicate to the particular user associated with the mobile user device 52 a recommended power state change of one or more smart devices in the region based on the predicted occupancy schedule of the region of the building.

For instance, the notification can be manifested as a power-off notification including information indicative of a recommendation to power-off one or more sockets in the region of the building. The power-off notification can be provided at or prior to a predicted unoccupied state in the predicted occupancy schedule for the region of the building (e.g., at or prior to a predicted last time that the user is predicted to be present in the region of the building). The notification can be manifested as a power-on notification including information indicative of a recommendation to power-one one or more smart sockets in the region of the building. The power-on notification can be provided at or prior to a predicted occupied state in the predicted occupancy schedule for the region of the building (e.g., at or prior to a predicted first time that the user is predicted to be present in the region of the building). These are merely examples and other types of notification can be provided.

In some instances, the notification can be provided (e.g., a signal indicative of the notification is wireless transmitted) prior to sending the signal to automatically switch power off or switch power on for one or more smart sockets in the region of the building. For example, the systems and methods herein can wirelessly provide the notification to at least one mobile user device corresponding to the at least one user with access to the region in the building. Thus, unlike some other approaches that may require a user to be physically present at a region in the building and/or manually interact directly with a smart socket, the approaches herein lend themselves to flexible power reduction of the smart sockets and electrical devices plugged into the smart sockets. As such, the systems and methods herein can reduce power consumption of the smart sockets and electrical appliances plugged into the smart sockets, and yet permit an added degree of flexibility for the one or more users who actually use the particular smart sockets (and electrical appliance plugged into the smart sockets) in the region of the building.

For instance, responsive to receipt of a notification, a user of the mobile user device 52 can opt to acknowledge a power state change recommendation included in the notification (e.g., accept the power state change recommendation to alter a power state of one or more smart sockets that is based on the predicted occupancy schedule) or can opt to reject the power state change recommendation in the notification (e.g., decline the recommendation to alter the power state of the one or more smart sockets is based on the predicted occupancy schedule), as indicated at 56-3. The acknowledgement or rejection of the notification can be wirelessly sent from the mobile user deice 52 to the supervisor 12. In some instances, the supervisor 12 can be configured to send a power-off notification to the at least one mobile user device such as the mobile user device 52, receive, from the at least one mobile user device, an acknowledgement of the power off notification, and responsive to receipt of the acknowledgement, sending a control signal to automatically switch power off to one or more smart sockets in the region of the building. In some instances, the supervisor 12 can be configured to send a power-on notification to the at least one mobile user device such as the mobile user device 52, receive, from the mobile user device, an acknowledgement of the power-on notification, and send the control signal to automatically switch power on to one or more smart sockets, responsive to receipt of the acknowledgement.

Conversely, in some instances, the supervisor 12 can be configured to send a power-off notification to the at least one mobile user device such as the mobile user device 52, receive, from the at least one mobile user device, a rejection of the power-off notification, and responsive to receipt of the rejection, delay or cease to send a control signal to automatically switch power off to one or more of the smart sockets in the region of the building. Similarly, in some instances, the supervisor 12 can be configured to send a power-on notification to the at least one mobile user device such as the mobile user device 52, receive, from the mobile user device, an acknowledgement of the power-on notification, and cease or delay sending the control signal to automatically switch power on to one or more of the smart sockets, responsive to receipt of the acknowledgement. That is, in some instances the signal to power on or power off the one or more smart sockets is not sent (e.g., is not sent to the one or more smart sockets) responsive to receipt of a rejection from the mobile user device. However, in some instances, the signal to power on or power off the one or more smart sockets can be delayed for a threshold amount of time (e.g., 1 hour, 2, hours, etc.) from a time that the notification is sent from the supervisor 12 and/or from a time that the reject is received by the supervisor 12. Subsequent to elapse of the threshold amount of time the signal to power off or power on the one or more smart sockets can be automatically sent to the one or more smart sockets (e.g., in the absence of a subsequent notification being provided to the mobile user device 52). However, in some instances the signal can be delayed until an acknowledgement is received from the mobile user device 52. For instance, responsive to receipt of a rejection, the supervisor 12 can send a subsequent notification (e.g., one hour after receiving the rejection, etc.) to the mobile user device 52 and a mobile user device can again opt to acknowledge or reject the subsequent notification. Any quantity or notifications or interval between respective notifications is possible. In some embodiments, the signal to power on or power off the one or more smart sockets can be sent responsive to receipt of a threshold quantity of rejections. For instance, responsive to receipt of three consecutive rejections from the mobile user device, the systems and methods herein can automatically send the signal (e.g., in the absence of an additional notification) to the mobile user device 52. However, as mentioned, in some instances responsive to one or more rejections the supervisor 12 can be configured to cease (not send) the signal to power on or power off the one or more smart sockets. The notification can be provided to an individual user with access to the region of the building or can be provided to one or more individual users with access to the region of the building. For instance, responsive to a rejection received from a particular authorized user (e.g., a supervisor of one of more users authorized to access the region of the building) the supervisor 12 may be configured to cease (not send) the signal to power on or power off the one or more smart sockets.

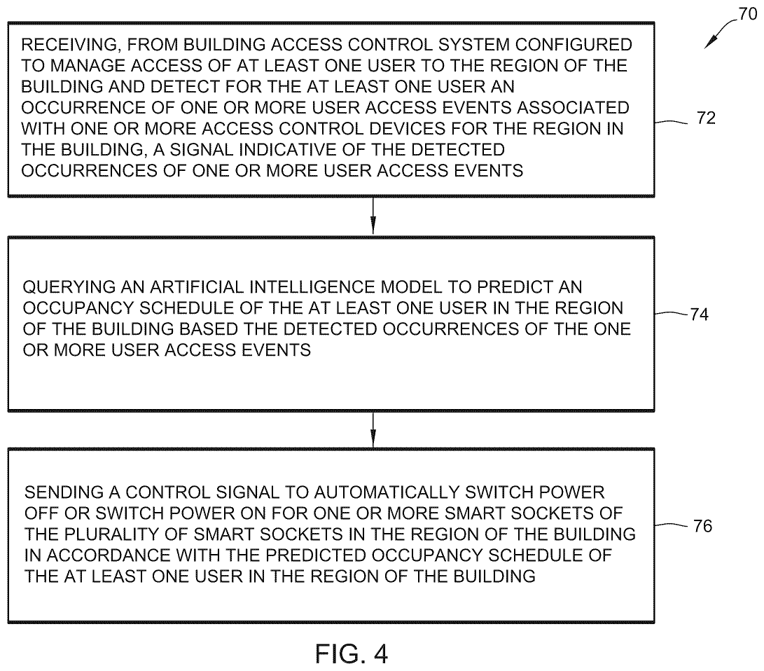

FIG. 4 shows an illustrative method 70 for reducing energy consumption of smart sockets based on a predicted occupancy schedule (e.g., predicted user access events in the predicted occupancy schedule). At 72, the method 70 includes receiving, from a building access control system, a signal indicative of the detected occurrences of one or more user access events, as described herein. As mentioned, the building access control system can be configured to manage access of at least one user to the region of the building and detect for the at least one user an occurrence of one or more user access events associated with one or more access control devices for the region in the building. At 74, the method 70 includes querying an artificial intelligence model to predict a predicted occupancy schedule of the at least one user in the region of the building based the detected occurrences of the one or more user access events, as described herein. At 76, the method 70 includes sending a control signal to automatically switch power off or switch power on for one or more smart sockets of the smart sockets in the region of the building in accordance with the predicted occupancy schedule of the at least one user in the region of the building, as described herein. As mentioned, in some instances, the method 70 includes providing the notification to the at least one user prior to sending the control signal, as detailed herein.

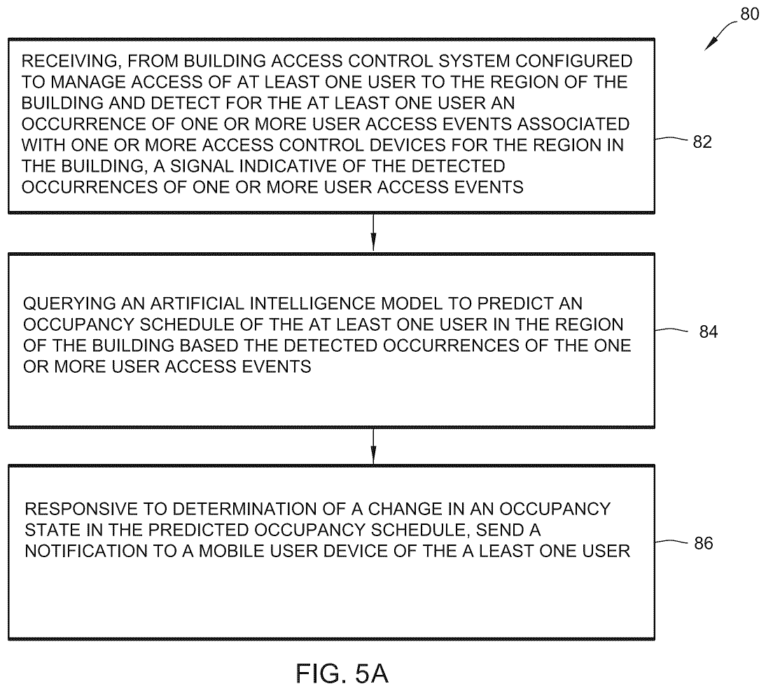

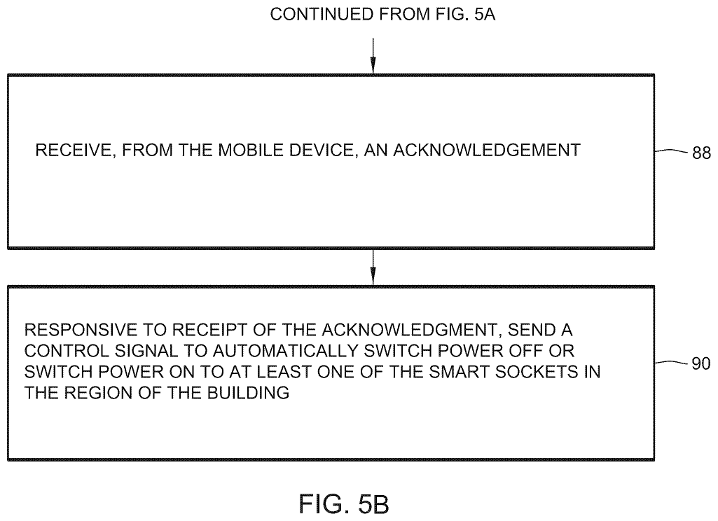

FIGS. 5A and 5B show another illustrative method 80 for reducing energy consumption of smart sockets based on a predicted occupancy schedule. At 82, the method 80 includes receiving, from building access control system configured to manage access of at least one user to the region of the building and detect for the at least one user an occurrence of one or more user access events associated with one or more access control devices for the region in the building, a signal indicative of the detected occurrences of one or more user access events, as detailed herein. At 84, the method 80 includes querying an artificial intelligence model to predict a precited occupancy schedule of the at least one user in the region of the building based the detected occurrences of the one or more user access events, as detailed herein. At 86, the method 80 includes sending a notification indicative of a recommendation to power on or power off the one or more smart sockets to a mobile user device of the a least one user. For instance, the notification can be sent responsive to determination of a change in an occupancy state in the predicted occupancy schedule, as detailed herein. At 88, the method 80 includes receiving, from the mobile device, an acknowledgement of the notification, as detailed herein. At 90, the method 80 includes sending a control signal to automatically switch power off or switch power on to at least one of the smart sockets in the region of the building. For instance, the control signal can be sent responsive to receipt of the acknowledgment of a power state change recommendation included in a notification, as detailed herein.

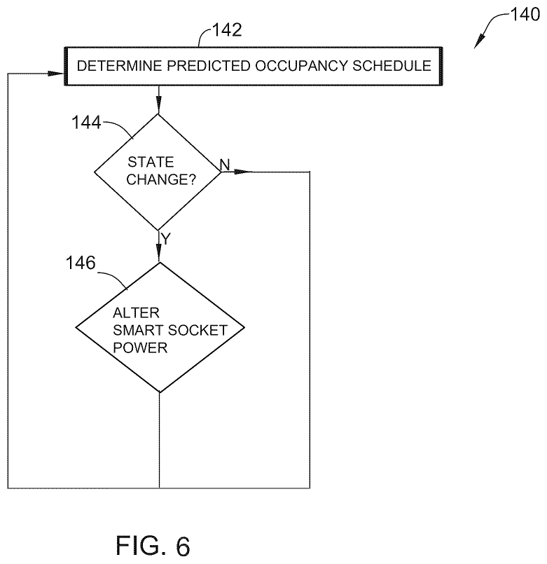

FIG. 6 is a flow diagram 140 showing an illustrative method for reducing energy consumption of smart sockets based on a predicted occupancy schedule. At 142, a predicated occupancy schedule of one or more users with access (e.g., as determined by a building access control system) to a region of a building can be determined, as indicated at block 142. As mentioned, a supervisor can query an artificial intelligence model to determine the predicted occupancy schedule.

At decision block 144, a determination is made as to whether there is a change in an occupancy state (e.g., a predicted occupancy state) in the predicated occupancy schedule. As mentioned, the determination can be made by a supervisor e.g., supervisory controller. If yes, control passes to block 146 and a power state of the one or more plug receptacles is altered (e.g., the one or more plug receptacles are powered on or powered off). For instance, the signal to alter the power state of the one or more plug receptacles can be sent responsive to receipt of an acknowledgement of a notification provide a mobile user device of a user with access to the region of the building, as described herein. If no, control returns to block 142.

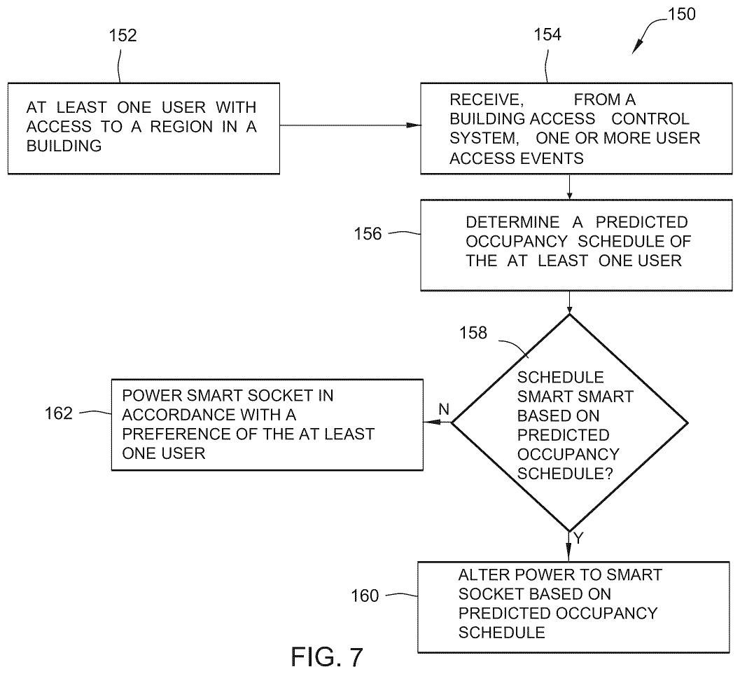

FIG. 7 is a flow diagram showing another illustrative method 150 for reducing energy consumption of smart sockets based on a predicted occupancy schedule. At 152, at least one user with access to a region in a building can access the region in the building and at least one user access event is determined (e.g., by a building access control system). At 154, a supervisor can receive from the building access control system, the one or more user access events (e.g., which correspond to the actual user accesses of the region of the building). That is, the one or more user access events can include at least historical user access event which corresponds to at least one historical user access of the region of the building). At 156, a predicted occupancy schedule of the at least one user and/or the region of the building is determined. For instance, the predicted occupancy schedule can be determined by a supervisor querying an artificial intelligence model, as described herein.

At decision block 158, a determination is made with or not to schedule a smart socket based on the predicated occupancy schedule. For instance, the determination may be made based on whether a user response to a notification provided to a mobile user device. For example, a supervisor can receive an acknowledgement to the notification and thus determine to schedule a smart socket based on the predicated occupancy schedule. In such instances, the method 150 can proceed to 160 where a signal is sent to alter power to the smart socket based on the predicted occupancy schedule. However, a supervisor can receive a rejection of the notification and thus determine to not power the one or more smart sockets in accordance with the predicted occupancy schedule. In such instances, the method 150 can proceed to 162 where a signal is not sent to the one or more smart sockets and the one or more smart sockets remain powered in accordance with the preference of the one or more users with access to the region of building.

Aspects of the illustrative methods herein can be performed with or via one or more of the components described herein. For instance, the illustrative methods herein can be performed in conjunction with or by at least a supervisor, a building access control system, and one or more smart sockets.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A system for controlling energy consumption of a region of a building, the system comprising:
a building access control system configured to manage access of at least one user to the region of the building and detect for the at least one user an occurrence of one or more user access events associated with one or more access control devices for the region in the building;
one or more smart sockets located in the region of the building, the one or more smart sockets each having:
a plug receptacle for receiving a plug from an electrical appliance; and
a socket controller that is configured to control whether the smart socket switches on or switches off power to the plug receptacle; and
a supervisor operatively coupled to the building access control system and each of the one or more smart sockets, the controller configured to:
query an artificial intelligence model to predict a predicted occupancy schedule of the at least one user in the region of the building based on the detected occurrences of the one or more user access events; and
send a control signal to automatically switch power off or switch power on for the one or more smart sockets in the region of the building based on the predicted occupancy schedule of the at least one user in the region of the building.

2. The system of claim 1, wherein the supervisor is configured to predict a change in an occupancy state of the region in the building based on the predicted occupancy schedule.

3. The system of claim 2, wherein:
in response to predicting a change from an unoccupied state to an occupied state in the predicted occupancy schedule, the controller is configured to send a control signal to switch power on to the one or more smart sockets; and
in response to predicting a change from the occupied state to the unoccupied state in the predicted occupancy schedule, the controller is configured to send a control signal to switch power off to the one or more smart sockets.

4. The system of claim 1, wherein the controller is further configured to query the artificial intelligence model to predict the predicted occupancy schedule responsive to an occurrence of a first user access event associated with the region of the building during a time period.

5. The system of claim 1, wherein the supervisor is further configured to query the artificial intelligence model to predict the predicted occupancy schedule responsive to an occurrence of a last user access event associated with the region of the building during a time period.

6. The system of claim 1, wherein the supervisor is configured to store the predicted occupancy schedule.

7. The system of claim 6, wherein the supervisor is further configured to send the control signal to automatically switch power off or switch power on for the one or more smart sockets in the region of the building in accordance with one or more predicted occupancy states in the predicted occupancy schedule.

8. The system of claim 1, wherein the detected occurrences of the one or more user access events are specific to an individual user with access to the region of the building.

9. The system of claim 1, wherein the detected occurrences of the one or more user access events are specific each user in a group of users each having access to the region of the building.

10. The system of claim 1, wherein the supervisor is operatively coupled to each of the one or more smart sockets via a wireless connection.

11. The system of claim 1, wherein the supervisor is operatively coupled to each of the one or more smart sockets via a gateway hub that is separate from the controller, wherein the gateway hub is in wireless communication with each of the one or more smart sockets.

12. A method for reducing energy consumption of a region of a building including a plurality of a smart sockets, the method comprising:
receiving, from a building access control system configured to manage access of at least one user to the region of the building and detect for the at least one user an occurrence of one or more user access events associated with one or more access control devices for the region in the building, a signal indicative of the detected occurrences of one or more user access events;
querying an artificial intelligence model to predict a predicted occupancy schedule of the at least one user in the region of the building based the detected occurrences of the one or more user access events; and
sending a control signal to automatically switch power off or switch power on for one or more of a plurality of smart sockets in the region of the building in accordance with the predicted occupancy schedule of the at least one user in the region of the building.

13. The method of claim 12, wherein the method further comprises providing a notification to a mobile user device of the at least one user with access to the region of the building.

14. The method of claim 13, further comprising providing the notification to the at least one user prior to sending the control signal.

15. The method of claim 13, further comprising wirelessly providing the notification to at least one mobile user device corresponding to the at least one user with access to the region in the building.

16. The method of claim 15, further comprising:
sending a power-off notification to the at least one mobile user device;
receiving, from the at least one mobile user device, an acknowledgement of the power-off notification; and
responsive to receipt of the acknowledgement, sending a control signal to automatically switch power off to one or more of the plurality of smart sockets in the region of the building.

17. The method of claim 15, further comprising:
sending a power-on notification to the at least one mobile user device;
receiving, from the mobile user device, an acknowledgement of the power-on notification; and
sending the control signal to automatically switch power on to one or more of the plurality of smart sockets.

18. A supervisor operatively coupled to a plurality of smart sockets in a region of a building and a building access control system of the building, each of the plurality of smart sockets having a housing including one or more plug receptacles, the supervisor comprising:
a memory storing non-transitory machine readable instructions; and
a processing device operatively coupled to the memory and configured to execute the non-transitory machine readable instructions stored in the memory to:
receive, from building access control system configured to manage access of at least one user to the region of the building and detect for the at least one user an occurrence of one or more user access events associated with one or more access control devices for the region in the building, a signal indicative of the detected occurrences of one or more user access events;
query an artificial intelligence model to predict a precited occupancy schedule of the at least one user in the region of the building based the detected occurrences of the one or more user access events;
responsive to determination of a change in an occupancy state in the predicted occupancy schedule, send a notification indicative of a recommendation to power on or power off the one or more of the plurality of smart sockets to a mobile user device of the a least one user;
receive, from the mobile device, an acknowledgement of the notification; and
responsive to receipt of the acknowledgment, send a control signal to automatically switch power off or switch power on to at least one of the plurality of smart sockets in the region of the building.

19. The controller of claim 18, wherein the non-transitory machine readable instructions further comprise instructions executable by the processing device to:
receive, from the mobile device, a rejection of the notification; and
delay or cease to send the control signal responsive to receipt of the rejection.

20. The controller of claim 18, wherein the non-transitory machine readable instructions further comprise instructions executable by the processing device to modify the predicted occupancy schedule responsive to an input from the at least one user.
